(19) United States
(12) Patent Application Publication
(10) Pub. No.: US 2015/0006342 A1
(43) Pub. Date: Jan. 1, 2015

(54) Generating a Simulated Invoice

(71) Applicant: MetraTech Corp., Waltham, MA (US)

(72) Inventors: Kenton A. Kline, Waltham, MA (US); Jason Mondanaro, Waltham, MA (US); Mario DeSousa, Waltham, MA (US)

(21) Appl. No.: 13/932,696

(22) Filed: Jul. 1, 2013

(51) Int. Cl. G06Q 30/04

(52) U.S. Cl. CPC G06Q 30/04
USPC 705/34

(57) ABSTRACT

A computer-implemented method includes accessing, by a computer, information indicative of a plurality of services included in a service plan template, with a service in the service plan template associated with a pricing model, and with the services in the service plan template being candidates for inclusion in a service plan; obtaining usage information indicative of amounts of prior usage of the services included in the service plan template; for a particular service included in the service plan template, selecting an item of usage information that is indicative of an amount of prior usage of the particular service; applying, to the selected item of usage information, a pricing model for the particular service; generating, based on applying, a forecast of a charge for the particular service; and generating, based on forecasts of charges for the services in the service plan template, a simulated invoice for the service plan template.

### BACKGROUND

In an example, a system generates invoices for customers of the system. Generally, an invoice is a commercial document issued by a seller to a buyer, indicating the products (and/or services), quantities, and agreed prices for products or services the seller has provided the buyer.

### SUMMARY

In one aspect of the present disclosure, a computer-implemented method includes accessing, by a computer, information indicative of a plurality of services included in a service plan template, with a service in the service plan template associated with a pricing model, and with the services in the service plan template being candidates for inclusion in a service plan; obtaining usage information indicative of amounts of prior usage of the services included in the service plan template; for a particular service included in the service plan template, selecting an item of usage information that is indicative of an amount of prior usage of the particular service; applying, to the selected item of usage information, a pricing model for the particular service; generating, based on applying, a forecast of a charge for the particular service; and generating, based on forecasts of charges for the services in the service plan template, a simulated invoice for the service plan template.

Implementations of the disclosure may include one or more of the following features. In some implementations, the method includes transmitting, to a client device, information indicative of the simulated invoice; receiving, from the client device, information indicative of approval of the services in the service plan template for inclusion in the service plan; and assigning the services to the service plan. In other implementations, the method includes determining, based on the simulated invoice, a first amount of forecasted profitability for a provider that provides the services in the service plan template; receiving, from the client device, information indicative of one or more modifications to the service plan template, with a modification comprising one or more of (i) a change in a type of service included in the service plan template, and (ii) a change in a pricing model of one of the services included in the service plan template; generating, based on the one or more modifications, a modified service plan template; updating, based on the one or more modifications and the usage information, the simulated invoice to represent forecasts of charges for services included in the modified service plan template; determining, based on the updated simulated invoice, a second amount of forecasted profitability to the provider; and determining, based on the first amount of forecasted profitability and the second amount of forecasted profitability, a change in an amount of forecasted profitability associated with the one or more modifications.

In still other implementations, the method includes generating information for a graphical user interface that when rendered on a display device, comprises: a first visual representation of the services included in the service plan template and the forecasts of the charges for the services included in the service plan template; and a second visual representation of the services included in the modified service plan template and the forecasts of charges for the services included in the modified service plan template; wherein the first visual representation is juxtaposed to the second representation in the graphical user interface.

In yet other implementations, the method includes transmitting, to a client device, information indicative of a graphical user interface that when rendered on a display device, comprises: a visual representation of the services included in the service plan template and the forecasts of the charges for the services. In still other implementations, the method includes generating a plurality of invoices for a plurality of consumers, with an invoice being for a consumer, and with the invoice including information indicative of amounts of services used by the consumer; and selecting a particular invoice from the plurality of invoices; wherein obtaining the usage information indicative of the amounts of prior usage of the services included in the service plan template comprises: identifying, in the selected particular invoice, information indicative of amounts of the services included in the service plan template that are used by one of the plurality of consumers who is associated with the selected particular invoice.

In still other implementations, the method includes accessing a group of invoices for a plurality of consumers, with an invoice being for a consumer, and with the invoice including usage information indicative of amounts of services used by the consumer; generating, based on applying the pricing models to usage information included in the invoices in the group, a plurality of simulated invoices; accessing information indicative of a first amount of revenue that is attributable to pricing models represented by the group of invoices; determining, based on the simulated invoices, a second amount of revenue that is attributable to the pricing models represented by the service plan template; and determining, based on comparing the first amount of revenue to the second amount of a revenue, a change in revenue that is attributable to the service plan template. In yet other implementations, at least one of the services in the service plan template comprises one or more of a telephony service, a data service and a video service. In other implementations, the method includes receiving, from a client device, information indicative of a selection of a plurality of services for inclusion in the service plan template.

In another aspect of the disclosure, one or more machine-readable storage media are configured to store instructions for causing one or more processing devices to perform operations comprising: accessing information indicative of a plurality of services included in a service plan template, with a service in the service plan template associated with a pricing model, and with the services in the service plan template being candidates for inclusion in a service plan; obtaining usage information indicative of amounts of prior usage of the services included in the service plan template; for a particular service included in the service plan template, selecting an item of usage information that is indicative of an amount of prior usage of the particular service; applying, to the selected item of usage information, a pricing model for the particular service; generating, based on applying, a forecast of a charge for the particular service; and generating, based on forecasts of charges for the services in the service plan template, a simulated invoice for the service plan template. Implementations of this aspect of the present disclosure can include one or more of the foregoing features.

In still another aspect of the disclosure, a system includes one or more processing devices; and one or more machine-readable media configured to store instructions that are executable to cause the one or more processing devices to perform operations comprising: accessing information indicative of a plurality of services included in a service plan template, with a service in the service plan template associated with a pricing model, and with the services in the service plan template being candidates for inclusion in a service plan; obtaining usage information indicative of amounts of prior usage of the services included in the service plan template; for a particular service included in the service plan template, selecting an item of usage information that is indicative of an amount of prior usage of the particular service; applying, to the selected item of usage information, a pricing model for the particular service; generating, based on applying, a forecast of a charge for the particular service; and generating, based on forecasts of charges for the services in the service plan template, a simulated invoice for the service plan template. Implementations of this aspect of the present disclosure can include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more embodiments are set forth in the accompanying drawings and the description below. Other features, objects, and advantages will be apparent from the description and drawings, and from the claims.

### BRIEF DESCRIPTION OF THE FIGURES

FIGS. 1A-1B are screen shots of graphical user interfaces for use in generating a simulated invoice.

FIG. 2 is an example of a network environment for generating a simulated invoice.

FIG. 3 is a block diagram showing examples of components used in the network environment for generating a simulated invoice.

FIG. 4 is a flowchart of a process for generating a simulated invoice.

FIG. 5 is a conceptual diagram of using groups of invoices and groups of simulated invoices in generating visual comparisons.

### DETAILED DESCRIPTION

A system consistent with this disclosure generates a simulated invoice. Generally, a simulated invoice includes a simulation (e.g., an imitation) of an invoice that is generated for a service plan template. Generally, a service plan template includes a set of services that are candidates for inclusion in a live service plan, e.g., a service plan that is offered for purchase by a service provider. There are various types of service plans, including, e.g., a service plan for telephony services, a service plan for mobile device services, a service plan for Internet services, a service plan for data services, and any combination thereof. In addition, the systems and methods described herein are not limited to communication and data services but can be generally applied to any product or service offered by a provider. For example, a cleaning service provider could simulate invoices based on services included and square footage of a location, a lawn care service could simulate invoices based on services such as grass cutting, trimming, weeding, leaf removal, and the like, a law firm could simulate invoices where some items have a fixed or pre-set fee and others are charged at an hourly rate. Additionally, in some examples, invoices can be simulated based on purchase of components or devices rather than or in addition to services.

In an example, a user (e.g., a service provider) of the system selects a set of services for inclusion in the service plan template. The system accesses previously generated invoices and selects, from the previously generated invoices, usage information for those services included in the service plan template. Generally, usage information includes information indicative of an amount of usage of a particular service. The system applies the selected usage information to pricing models for the services in the service plan template. Based on application of the selected usage information to the pricing models, the system generates the simulated invoice, which includes forecasts of charges for the services included in the service plan template.

By evaluating the forecast of the charges, the service provider may modify the set of services included in the service plan template. The service provider may also modify the pricing models, associated fees, or both for the various services in the service plan template. By modifying the services and the pricing models, the service provider may identify an optimum pricing level for services included in live service plans.

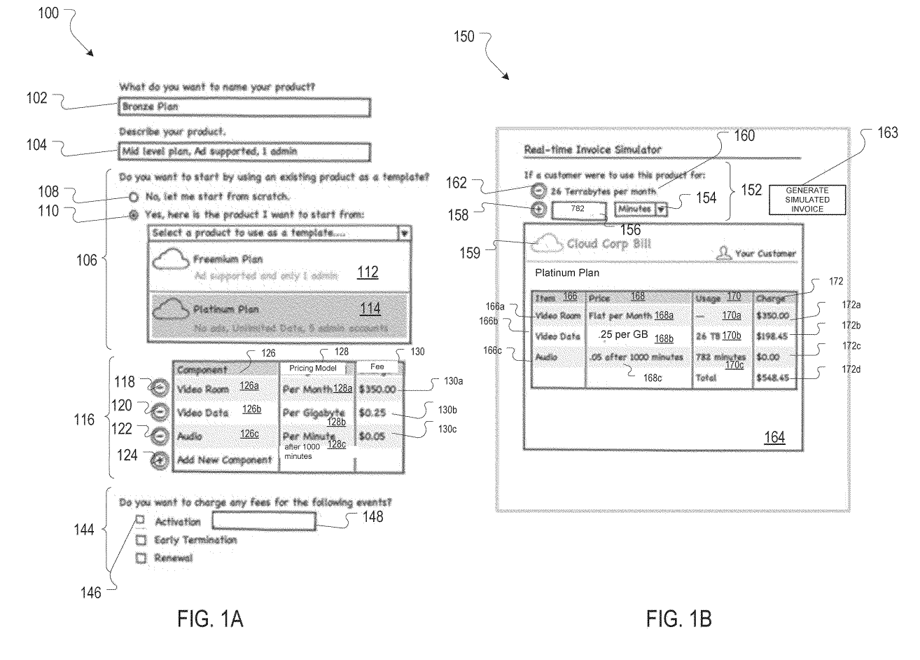

Referring to FIG. 1A, graphical user interface 100 displays information for enabling a user (e.g., a service provider) to generate a service plan template. In this example, the service plan template includes a plan (e.g., a product) that is a candidate for inclusion in a plan catalog of a service provider. Graphical user interface 100 includes portion 102 for entry of information indicative of a name of the service plan template. Graphical user interface 100 includes portion 104 for entry of information indicative of a description of the service plan template. Graphical user interface 100 also includes portion 106 for user selection of an existing plan as the service plan template. Portion 106 includes control 108, selection of which specifies that the user requests to generate the service plan template independent of an existing plan. Portion 106 also includes control 110, selection of which specifies that the user requests to generate the service plan template based on an existing plan. Following selection of control 110, graphical user interface 100 is updated to display existing plan information 112, 114 indicative of existing plans that may be used in generating the service plan template.

In the example of FIG. 1A, a user selects existing plan information 114 to specify that the service plan template includes the services included in the existing plan specified by existing plan information 114. Following selection of existing plan information 114, graphical user interface 100 is updated to display portion 116, which displays service information 126 indicative of the services that are included in the existing plan specified by existing plan information 114. The services included in the selected existing plan are of various types, including, e.g., a video room service, a video data service and an audio service, as specified by video room service information 126a, video data service information 126b and audio service information 126c, respectively. Service information 126 is associated with pricing model information 128 and fee information 130. Generally, a pricing model includes information indicative of a manner in which fees are set for a given service. Pricing model information 128 includes various items, including e.g., items 128a, 128b, 128c of pricing model information 128. Fee information 130 includes various items, including e.g., items 130a, 130b, 130c of fee information 130.

In the example of FIG. 1A, video room service information 126a, video data service information 126b and audio service information 126c are associated with items 128a, 128b, 128c of pricing model information 128 and items 130a, 130b, 130c of fee information 130, respectively. Portion 116 also includes controls 118, 120, 122 for removal of one or more services specified by video room service information 126a, video data service information 126b and audio service information 126c, respectively, from the service plan template. Portion 116 also includes control 124, selection of which enables a user to add another service to the service plan template. Using one or more of controls 118, 120, 122, 124, a user may modify the services included in a service plan template. In this example, the information displayed in portion 116 displays the service plan template.

Graphical user interface 100 also include portion 144 for selection of additional events and fees to be included in the service plan template. For example, selection of control 146 includes an activation fee in the service plan template. In this example, a user may enter into input box 148 information indicative of a fee amount to be charged for activation.

Referring to FIG. 1B, graphical user interface 150 displays information for generation (e.g., in real-time) of a simulated invoice, e.g., simulated invoice 164. In this example, graphical user interface 150 includes portion 152 for entry of usage information for the various services included in the service plan template. Portion 152 includes usage information 160 for video data service 126b. Usage information 160 is associated with control 162, selection of which removes usage information 160 from being used in generating a simulated invoice. Portion 152 also includes control 158, selection of which enables a user to enter various other types of usage information for the other types of services included in the service plan template. Following selection of control 158, graphical user interface 150 is updated with control 154. Using control 154, a user may select a type of usage information to be used in generating the simulated invoice. Control 154 is associated with input box 156, e.g., for a user to enter an amount of the usage information selected by control 154. In the example of FIG. 1B, a user uses control 154 to select usage information that is of a telephony type. In this example, telephony usage is measured in minutes. Control 154 displays the verbiage “minutes” to indicate that the type of usage information is telephony. A user may input into input box 156 information indicative of a number of minutes to be used in generating the simulated invoice. As described in further detail below, usage information may also be obtained through past invoices, e.g., rather than through manual entry of usage information into portion 152 of graphical user interface 150.

Graphical user interface 150 includes simulation control 163. Upon selection of simulation control 163, the system described herein generates simulated invoice 164. In this example, simulated invoice 164 is based on (i) the usage information specified in portion 152 of graphical user interface 150, (ii) services included in the service plan template (as specified by video room service information 126a, video data service information 126b and audio service information 126c), (iii) items 128a, 128b, 128c of pricing model information 128 (FIG. 1A) and (iv) items 130a, 130b, 130c of fee information 130 (FIG. 1A).

In the example of FIG. 1B, simulated invoice 164 displays service information 166 that specifies the services that are included in the service plan template from which simulated invoice 164 is generated. The services include a video room service, a video data service, and an audio service, e.g., as specified by video room service information 166a, video data service information 166b, and audio service information 166c, respectively. In this example, video room service information 166a, video data service information 166b, and audio service information 166c specify the same types of services as specified by video room service information 126a, video data service information 126b, and audio service 126c information of FIG. 1A, respectively.

Simulated invoice 164 also displays pricing information 168, usage information 170 and charge information 172. Pricing information 168 is based on pricing model information 128 and fee information 130, as specified in the service plan template shown in portion 116 of graphical user interface 100 (FIG. 1A). In this example, pricing information 168 specifies a price that a customer is charged for use of a predetermined amount of a service. Charge information 172 is based on usage information 170 and pricing information 168. In this example, charge information 172 specifies a forecasted amount that a user is charged for a particular service, based on the amount the user uses the particular service (e.g., as specified by usage information).

Pricing information 168 includes various items, including, e.g., items 168a, 168b, 168c of pricing information 168. Usage information 170 includes various items, including e.g., items 170a, 170b, 170c of usage information 170. Charge information 172 also includes various items, including, e.g., items 172a, 172b, 172c of charge information 172. In the example of FIG. 1B, video room service information 166a, video data service information 166b and audio service information 166c are associated with (i) items 168a, 168b, 168c of pricing information 168, (ii) items 170a, 170b, 170c of usage information 170, and (iii) items 172a, 172b, 172c of charge information 172, respectively.

In the example of FIG. 1B, simulated invoice 164 also includes aggregate charge information 172d, which specifies an aggregated amount of items 172a, 172b, 172c of charge information 172. Aggregate charge information 172d is indicative of a total amount a user is invoiced for usage of the services included in the service plan template.

In a variation of FIG. 1B, simulated invoice 164 may include a company's branding information 159 (e.g., a branding logo and/or branding banner). This branding information 159 can be, for example, a logo or other information that represents a company's branding. In this example, simulated invoice 164 may be used to visualize an actual invoice using the company's branding information.

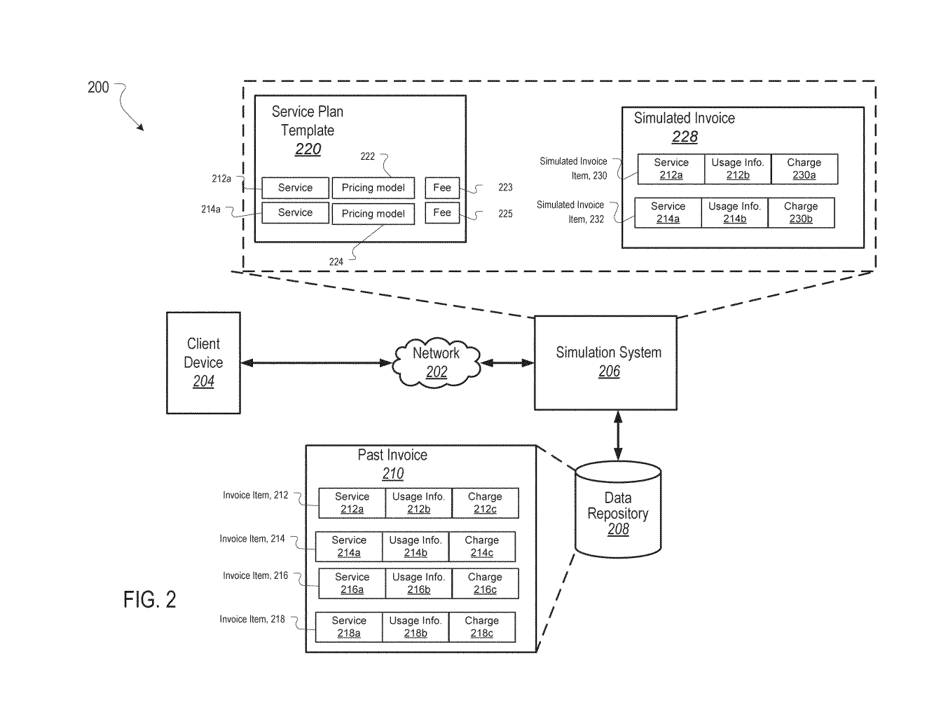

Referring to FIG. 2, network environment 200 is configured for generation of simulated invoice 228. In this example, network environment 200 includes network 202, client device 204, simulation system 206 and data repository 208. Simulation system 206 includes a system for generating (e.g., periodically and/or in real-time) simulated invoices.

In the example of FIG. 2, data repository 208 stores past invoices, e.g., past invoice 210. Generally, a past invoice is an invoice that is previously generated for a consumer, e.g., based on the consumer's actual usage of services. Data repository 208 may be configured to store thousands and/or millions of past invoices. In this example, past invoice 210 is an invoice for a user's consumption of mobile telephony and data services. Past invoice 210 includes invoice items 212, 214, 216, 218. Generally, an invoice item includes a portion of information in an invoice that pertains to a particular service. In this example, invoice item 212 includes service information 212a, usage information 212b and charge information 212c. Service information 212a includes information indicative of a particular service for which a consumer is invoiced. Usage information 212b includes information indicative of an amount of the particular service that the consumer has used. Charge information 212c includes information indicative of an amount of money the consumer was charged for use of the particular service. In this example, invoice item 214 includes service information 214a, usage information 214b and charge information 214c. Invoice item 216 includes service information 216a, usage information 216b and charge information 216c. Invoice item 218 includes service information 218a, usage information 218b and charge information 218c.

In this example, client device 204 is used by a service provider (not shown). Using client device 204, the service provider transmits service plan template 220 to simulation system 206. In this example, service plan template 220 includes service information 212a, 214a that specifies services that are candidates for inclusion in a live service plan. Service information 212a, 214a are associated with pricing model information 222, 224 and fee information 223, 225.

Following receipt of service plan template 220, simulation system 206 parses contents of service plan template 220. Based on the parsing, simulation system 206 determines the types of services included in service plan template 220. In this example, the types of services are specified by service information 212a, 214a. Simulation system 206 selects, from data repository 208, an invoice that includes charges and usage information for at least a portion of the services included in service plan template 220.

In an example, simulation system 206 compares types of services represented by the invoices in data repository 208 to the types of services included in service plan template 220. Simulation system 206 selects one or more invoices with services matching at least a portion of services included in service plan template 220. When simulation system 206 detects a plurality of invoices with services matching at least a portion of services included in service plan template 220, simulation system 206 implements various techniques for determining which invoices to select for use in generating simulated invoice 228. In an example, simulation system 206 is configured to select a predetermined number of invoices. In this example, simulation system 206 randomly selects the predetermined number of invoices, e.g., from the plurality of invoices with services matching at least a portion of services included in service plan template 220. In another example, in addition to or instead of the system determining and matching past invoices and usage to the service plan template, the user can also manually configure a simulated invoice to have specific service, usage, and charge info in order to generate a simulated invoice. In such example, the user could either pick an old invoice to use as the basis of the simulation or create a new one to test specific pricing scenarios. In another example, simulation system 206 selects, from the plurality of invoices with services matching at least a portion of services included in service plan template 220, those invoices that are more recently generated, e.g., relative to a time when other of the invoices are generated.

In the example of FIG. 2, simulation system 206 determines that past invoice 210 is for at least some of the services included in service plan template 220. In particular, simulation system 206 determines a match among service information 212a, 214a included in service plan template 220 and service information 212a, 214a included in past invoice 210. Based on the determined match, simulation system 206 selects past invoice 210 for use in generating simulated invoice 228.

In the example of FIG. 2, simulation system 206 selects, from past invoice 210, usage information 212b, 214b for the services included in service plan template 220, e.g., as represented by service information 212a, 214a. Simulation system 206 generates simulated invoice 228 by sending usage information 212b, 214b through service plan template 220. In an example, usage information 212b, 214b is sent through service plan template 220 by performing the following operations.

For the service represented by service information 212a, simulation system 206 applies usage information 212b to pricing model information 222 and fee information 223. Based on application of usage information 212b to pricing model information 222 and fee information 223, simulation system 206 determines a charge for use of the service represented by service information 212a. The determined charge is represented by charge information 230a in simulated invoice 228. In an example, the service represented by service information 212a may be a telephony service for a consumer to talk on a mobile device. In this example, usage information 212b indicates that one-hundred minutes of talk time were used by a consumer associated with past invoice 210. Pricing model information 222 indicates that service provider charges per minute of talk time. Fee information 223 indicates that the service provider charges $0.25. In this example, simulation system 206 generates a value for charge information 230 by multiplying the value of usage information 212b (e.g., 100 minutes) by the value of fee information 223 (e.g., $0.25) in accordance with pricing model information 222 (e.g., per minute of talk time). In this example, the value of charge information 230a is twenty-five dollars (e.g., 100 minutes×$0.25/minute=$25.00).

For the service represented by service information 214a, simulation system 206 applies usage information 214b to pricing model information 224 and fee information 225. Based on application of usage information 214b to pricing model information 224 and fee information 225, simulation system 206 determines a charge for use of the service represented by service information 214a. The determined charge is represented by charge information 230b in simulated invoice 228.

In the example of FIG. 2, simulated invoice 228 includes simulated invoice items 230, 232. Simulated invoice item 230 specifies a forecast of a charge (e.g., charge information 230a) for usage of a service represented by service information 212a. In this example, simulated invoice item 230 displays service information 212a, in association with usage information 212b, and in association with charge information 230a. In this example, simulated invoice item 232 displays service information 214a, in association with usage information 214b, and in association with charge information 230b.

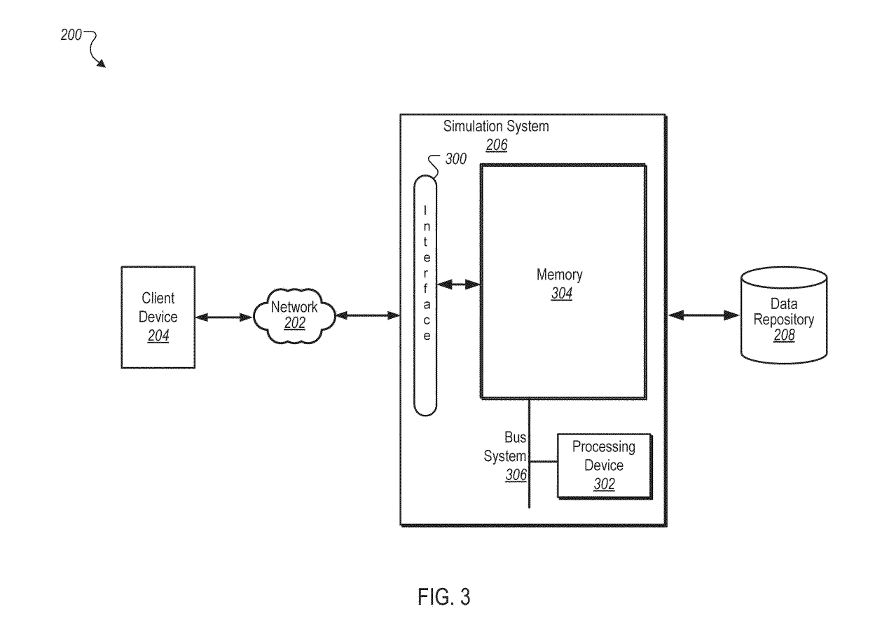

Referring to FIG. 3, simulation system 206 can be a variety of computing devices capable of receiving data and running one or more services, which can be accessed by client device 204. In an example, simulation system 206 can include a server, a distributed computing system, a desktop computer, a laptop, a cell phone, a rack-mounted server, any combination of the foregoing, and the like. Simulation system 206 can be a single server or a group of servers that are at a same position or at different positions. Simulation system 206 and client device 204 can run programs having a client-server relationship to each other. Although distinct modules are shown in the figures, in some examples, client and server programs can run on the same device.

Simulation system 206 can receive data from client device 204 through input/output (I/O) interface 300. I/O interface 300 can be a type of interface capable of receiving data over a network, including, e.g., an Ethernet interface, a wireless networking interface, a fiber-optic networking interface, a modem, and so forth. Simulation system 206 also includes a processing device 302 and memory 304. A bus system 306, including, for example, a data bus and a motherboard, can be used to establish and to control data communication between the components of simulation system 206.

Processing device 302 can include one or more microprocessors. Generally, processing device 302 can include an appropriate processor and/or logic that is capable of receiving and storing data, and of communicating over a network. Memory 304 can include a hard drive and a random access memory storage device, including, e.g., a dynamic random access memory, or other types of non-transitory machine-readable storage devices. As shown in FIG. 3, memory 304 stores computer programs (not shown) that are executable by processing device 302. These computer programs may include a data engine (not shown) for implementing the operations and/or the techniques described herein. The data engine can be implemented in software running on a computer device (e.g., simulation system 206), hardware or a combination of software and hardware.

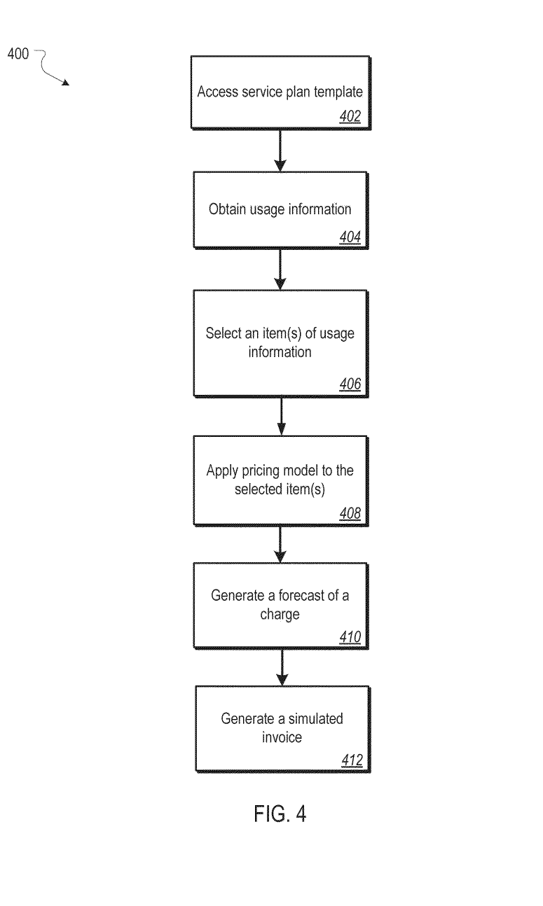

Referring to FIG. 4, simulation system 206 implements process 400 in generating a simulated invoice. In operation, simulation system 206 accesses (402) a service plan template, including, e.g., service plan template 220. In this example, simulation system 206 accesses the service plan template from data repository 208. Simulation system 206 also obtains (404) usage information indicative of amounts of prior usage of the services included in the service plan template. As previously described, usage information may be obtained from invoices (e.g., past invoices) that are stored in data repository 208. For a particular service included in the service plan template, simulation system 206 selects (406) an item (and/or items) of usage information that is indicative of an amount of prior usage of the particular service. In this example, simulation system 206 selects an item of usage information by identifying, in a past invoice, usage information that is associated with a service that is included in the service plan template.

In the example of FIG. 4, simulation system 206 also applies (408), to the selected item(s) of usage information, a pricing model for the particular service, with the pricing model being specified in the service plan template. In addition to application of the pricing model, simulation system 206 also applies fee information to the usage information, with the fee information being applied in accordance with the pricing model. In this example, simulation system generates (410) a forecast of a charge for a service included in the service plan template. Examples of forecasted charges are represented by charge information 230a, 230b in simulated invoice 228 (FIG. 2). Based on forecasts of charges for the services in the service plan template, simulation system 206 generates (412) a simulated invoice for the service plan template.

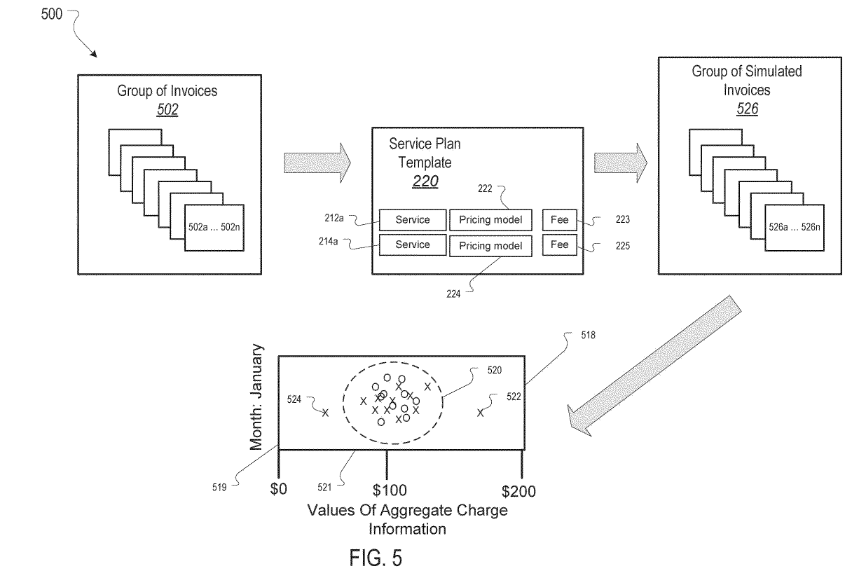

Referring to FIG. 5, conceptual view 500 depicts use of a group 502 of invoices 502a . . . 502n and a group 526 of simulated invoices 526a . . . 526n to identify pricing aberrations (e.g., errors) in service plan template 220. In this example, group 502 of invoices 502a . . . 502n may include many hundreds and/or thousands of invoices. Simulation system 206 (FIG. 2) selects group 502 of invoices 502a . . . 502n based on detection in invoices 502a . . . 502n of one or more of service information 212a, 214a. In an example, each of invoices 502a . . . 502n is for one or more services included in service plan template 220.

In the example of FIG. 5, simulation system 206 applies group 502 of invoices 502a . . . 502n to service plan template 220. Based on application of group 502 of invoices 502a . . . 502n to service plan template 220, simulation system 206 generates group 526 of simulated invoices 526a . . . 526n. In an example, simulation system 206 applies group 502 of invoices 502a . . . 502n to service plan template 220 by performing the following operations for invoices 502a . . . 502n.

For a particular one of invoices 502a . . . 502n, simulation system 206 selects, from the particular invoice, usage information that is representative of usage of the services included in service plan template 220. Simulation system 206 applies the appropriate, selected usage information to pricing model information 222, 224 and fee information 223, 224. Based on application of the usage information to pricing model information 222, 224 and fee information 223, 224, simulation system 206 determines charges for use of the services included in service plan template 220. Using these determined charges, simulation system 206 generates one or more of simulated invoices 526a . . . 526n. Simulation system 206 repeats the above-described actions for each of invoices 502a . . . 502n to generate simulated invoices 526a . . . 526n. In an example, group 526 of simulated invoices 526a . . . 526n includes thousands of simulated invoices. In this example, invoices 502a . . . 502n are for a particular period of time (e.g., the month of January). In accordance with invoices 502a . . . 502n being for a particular period of time, simulated invoices 526a . . . 526n are also for the same particular period of time.

Using simulated invoices 526a . . . 526n, simulation system 206 generates graph 518 (e.g., a scatterplot graph). Graph 518 plots values of aggregate charge information (for simulated invoices 526a . . . 526n and invoices 502a . . . 502n) as a function of time. In this example, graph 518 includes y-axis 519, which represents a particular period of time (e.g., the month of January). Graph 518 also include x-axis 521, which represents values (e.g., dollar amounts) for aggregate charge information.

Graph 518 includes various data points. Data points represented by the symbol “O” represent a value for aggregate charge information included in a past invoice (e.g., one of invoices 502a . . . 502n). Data points represented by the symbol “X” represent a value for aggregate charge information included in a simulated invoice (e.g., one of simulated invoices 526a . . . 526n). In this example, the majority of data points plotted in graph 518 are clustered in region 520. The clustering of data points in region 520 represents that aggregate charges for the majority of simulated invoices 526a . . . 526n are substantially in accordance with aggregate charges for invoices 502a . . . 502n.

In this example, the pricing models and fees employed in service plan template 220 differ from the pricing models and fees used in the service plans represented in invoices 502a . . . 502n. The clustering of data points (for both simulated invoices 256a . . . 256n and invoices 502a . . . 502n) in region 520 represents these difference in pricing models and fees do not substantially alter the aggregate charges for the majority of simulated invoices 526a . . . 526n. Graph 518 includes data points 522, 524, which are statistical outliers. In this example, data points 522, 524 are outside of region 520.

In this example, a service provider may view graph 518 (e.g., via client device 204). In this example, simulation system 206 sends information indicative of graph 518 to client device 204, e.g., for rendering on a display of client device 204. The service provider reviews graph 518 to identify potential pricing aberrations (e.g., errors) in pricing models and/or fees included in service plan template 220. In this example, data points 522, 524 are indicative of simulated invoices that include either a decreased aggregate charge (e.g., relative to other aggregate charges) and/or an increased aggregate charge (e.g., relative to other aggregate charges). Data points 522, 524 are associated with identification information (not shown) that enables a service provider to identify which ones of simulated invoices 526a . . . 526n are associated with data points 522, 524. The identification information may include a unique invoice number.

Simulation system 206 enables the service provider to access and to view the simulated invoices associated with data points 522, 524. In this example, simulation system 206 notifies the service provider that the aberrations represented by data points 522, 524 may be caused by errors in one or more of the pricing models and the fees included in service plan template 220.

Simulation system 206 also enables the service provider to request that simulation system 206 detect potential reasons for the aberrations represented by data points 522, 524. In this example, simulation system 206 is configured to detect errors in one or more of the pricing models and the fees included in service plan template 220. These errors are detected by running previous invoices through a new service plan template to generate a simulated invoices and identifying potential issues.

For example, if the user deletes one or more services from the template, the simulated invoice can be configured to alert the user that there is missing product/service information so this can potentially be fixed if the deletion was unintentional.

In another example, the user might have changed units of measure (like from MB to GB) and the previous invoice was using a different unit. Alerting the user on the simulated invoice or in the graph provides the user with the opportunity to correct the units if the modification was unintentional.

In another example, the user can set a threshold for differences in total charges for the invoice. The system can alert the user if the total charges for the simulated invoice differs significantly from the charges in the actual invoice (e.g., if the difference exceeds the threshold). For example, if a user is modifying the pricing of a service, the user may desire that the pricing does not chamber by more than 10% (positive or negative). The user provides the past invoices into the invoice simulator to generate the simulated invoices. If the pricing on the simulated invoices differs by more than the threshold (E.g., 10%) then an error should is generated.

In some additional examples, an error could should be generated if the input data does not match the output data that determines the charges. Previous invoices should usually have the same type of services, usage, units, and product models so that pricing can be optimized. If these types of data do not match between the actual invoices and the pricing model, then the system can generate an error to alert the user to a possible mistake. In another example, through analysis of contents the ones of simulated invoices 526a . . . 256n that are associated with data points 522, 524, simulation system 206 may identify types of usage information that cause the aberrations in the aggregate charges. For example, simulation system 206 may detect that the pricing models and/or fees included in service plan template 220 may produce a decreased aggregate charge (e.g., relative to other aggregate charges), e.g., when an amount of usage information is below a threshold amount. In another example, simulation system 206 may detect that the pricing models and/or fees included in service plan template 220 may produce an increased aggregate charge (e.g., relative to other aggregate charges), e.g., when an amount of usage information is above a threshold amount.

In this example, simulation system 206 generates an alert that notifies the service provider of the determined potential reasons for the aberrations. Using these determined reasons, the service provider may instruct simulation system 206 to generate another version of service plan template 220, e.g., by modifying one or more of the types of services included in the service plan template 220, the fees for the services included in service plan template 220, and/or the pricing model. Following implementation of these modifications, simulation system 206 may generate another group of simulated invoices, e.g., to determine if the modifications decrease a number of aberrations (e.g., relative to a number of aberrations prior to implementation of the modifications). Simulation system 206 continues implementing modifications to service plan template 220, e.g., until a service provider determines that a particular version of service plan template 220 represents an optimal pricing scheme for various services. Upon determination that a particular version of service plan template 220 represents an optimal pricing scheme for various services, simulation system 206 assigns to a live service plan the services that are included in the version of service plan template 220 with the optimal pricing scheme. In an example, an optimal pricing scheme includes a combination of a pricing model and fee that produces an increased amount of revenue, e.g., relative to amounts of revenue produced by other pricing models and fees.

In an example, simulation system 206 transmits, to client device 204, information indicative of a simulated invoice. In this example, the service provider reviews the simulated invoice, which may be based on numerous modifications to a service plan template. After review of the simulated invoice, the service provider approves the simulated invoice. In this example, the service provider's approval of the simulated invoice also indicates approval of the underlying service plan template from which the simulated invoice is generated. In this example, client device 204 transmits, to simulation system 206, information indicative of approval of the services in the service plan template for inclusion in a service plan (e.g., a live service plan). In response, simulation system 206 assigns the services in the service plan template to the service plan.

Simulation system 206 may use contents of invoices 526a . . . 526n in group 526 to perform various types of statistical analysis. In an example, simulation system 206 accesses, from data repository 208, information indicative of an amount of revenue that is attributable to pricing models of service plans represented by group 502 of invoices 502a . . . 502n. Simulation system 206 also determines, based on simulated invoices 526a . . . 526n, another amount of revenue that is attributable to the pricing models represented by service plan template 220. In this example, simulation system 206 compares the amount of revenue that is attributable to pricing models of service plans represented by group 502 of invoices 502a . . . 502n to the amount of revenue that is attributable to the pricing models represented by service plan template 220. Using results of the comparing, simulation system 206 determines a change in revenue that is attributable to service plan template 220. In this example, simulation system 206 sends, to client device 204, information indicative of the change in revenue that is attributable to service plan template 220. A service provider may use client device 204 to review this information. This information promotes the service provider understanding how changes in services offered and/or how changes in pricing models affect the service provider's revenue. For example, the system can generate a detailed comparison of aggregate pricing and revenue to see how types of income are generated. For example, the system can determine if recurring revenue increased or decreased. The system can also perform analysis of how profitability will change with the acquisition of new customers or loss of existing customers. For example, the system can perform simulations to determine if the company were to loose N customers because of price increases, will the change in pricing still be profitable to the business?

In another example, simulation system 206 may generate other graphs (not shown) with varying levels of granularity, e.g., a level of granularity of charges for a particular service included in a service plan template. In this example, simulation system 206 may use these other graphs to detects aberrations in charges for a particular service, e.g., rather than aberrations in aggregate charges for an entire invoice.

In still another example, simulation system 206 is configured to generate forecasts of profitability, e.g., based on forecasts of charges in simulated invoices. In this example, simulation system 206 determines, based on simulated invoices (e.g., simulated invoices 526a . . . 526n), a forecasted amount profitability for a service provider that provides the services in a service plan template. As previously described, the service provider may implement various modifications to an original service plan template, e.g., to determine an optimal pricing scheme. In this example, simulation system 206 receives, from client device 204, information indicative of one or more modifications to the service plan template. In this example, a modification includes one or more of (i) a change in a type of service included in the service plan template, and (ii) a change in a pricing model of one of the services included in the service plan template. Simulation system 206 generates, based on the one or more modifications, a modified service plan template.

In this example, simulation system 206 generates, based on the one or more modifications, another set of simulated invoices to represent forecasts of charges for services included in the modified service plan template. Simulation system 206 determines, based on contents of the other set of simulated invoices, an amount of forecasted profitability that is associated with the modified service plan template. Simulation system uses the amounts of forecasted profitability for the original service plan template and the modified service plan template to determine a change in an amount of forecasted profitability associated with the one or more modifications.

In another example, simulation system 206 generates information for a graphical user interface (not shown) that when rendered on a display device, displays a visual representation of the services included in the original service plan template and the forecasts of the charges for the services included in the original service plan template. In this example, the graphical user interface also displays another visual representation of the services included in the modified service plan template and the forecasts of charges for the services included in the modified service plan template. In this example, the graphical user interface displays the visual representations in juxtaposition to each other, e.g., to promote visual review by a service provider of the differences in forecast charges that result from the modifications to the original service plan template.

Embodiments can be implemented in digital electronic circuitry, or in computer hardware, firmware, software, or in combinations thereof. Apparatus of the techniques described herein can be implemented in a computer program product tangibly embodied or stored in a machine-readable media (e.g., storage device) for execution by a programmable processor; and method actions can be performed by a programmable processor executing a program of instructions to perform operations of the techniques described herein by operating on input data and generating output. The techniques described herein can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
accessing, by a computer, information indicative of a plurality of services included in a service plan template, with a service in the service plan template associated with a pricing model, and with the services in the service plan template being candidates for inclusion in a service plan;
obtaining, by the computer, usage information indicative of amounts of prior usage of the services included in the service plan template;
for a particular service included in the service plan template,
selecting an item of usage information that is indicative of an amount of prior usage of the particular service;
applying, to the selected item of usage information, a pricing model for the particular service;
generating, based on applying, a forecast of a charge for the particular service; and
generating, based on forecasts of charges for the services in the service plan template, a simulated invoice for the service plan template.

2. The computer-implemented method of claim 1, further comprising:
transmitting, to a client device, information indicative of the simulated invoice;
receiving, from the client device, information indicative of approval of the services in the service plan template for inclusion in the service plan; and
assigning the services to the service plan.

3. The computer-implemented method of claim 1, further comprising:
determining, based on the simulated invoice, a first amount of forecasted profitability for a provider that provides the services in the service plan template;
receiving, from the client device, information indicative of one or more modifications to the service plan template, with a modification comprising one or more of (i) a change in a type of service included in the service plan template, and (ii) a change in a pricing model of one of the services included in the service plan template;
generating, based on the one or more modifications, a modified service plan template;
updating, based on the one or more modifications and the usage information, the simulated invoice to represent forecasts of charges for services included in the modified service plan template;
determining, based on the updated simulated invoice, a second amount of forecasted profitability to the provider; and
determining, based on the first amount of forecasted profitability and the second amount of forecasted profitability, a change in an amount of forecasted profitability associated with the one or more modifications.

4. The computer-implemented method of claim 3, further comprising:
generating information for a graphical user interface that when rendered on a display device, comprises:
a first visual representation of the services included in the service plan template and the forecasts of the charges for the services included in the service plan template; and
a second visual representation of the services included in the modified service plan template and the forecasts of charges for the services included in the modified service plan template;
wherein the first visual representation is juxtaposed to the second representation in the graphical user interface.

5. The computer-implemented method of claim 1, further comprising:
transmitting, to a client device, information indicative of a graphical user interface that when rendered on a display device, comprises:
a visual representation of the services included in the service plan template and the forecasts of the charges for the services.

6. The computer-implemented method of claim 1, further comprising:
generating a plurality of invoices for a plurality of consumers, with an invoice being for a consumer, and with the invoice including information indicative of amounts of services used by the consumer; and
selecting a particular invoice from the plurality of invoices;
wherein obtaining the usage information indicative of the amounts of prior usage of the services included in the service plan template comprises:
identifying, in the selected particular invoice, information indicative of amounts of the services included in the service plan template that are used by one of the plurality of consumers who is associated with the selected particular invoice.

7. The computer-implemented method of claim 1, further comprising:
accessing a group of invoices for a plurality of consumers, with an invoice being for a consumer, and with the invoice including usage information indicative of amounts of services used by the consumer;
generating, based on applying the pricing models to usage information included in the invoices in the group, a plurality of simulated invoices;
accessing information indicative of a first amount of revenue that is attributable to pricing models represented by the group of invoices;
determining, based on the simulated invoices, a second amount of revenue that is attributable to the pricing models represented by the service plan template; and
determining, based on comparing the first amount of revenue to the second amount of a revenue, a change in revenue that is attributable to the service plan template.

8. The computer-implemented method of claim 1, wherein at least one of the services in the service plan template comprises one or more of a telephony service, a data service and a video service.

9. The computer-implemented method of claim 1, further comprising:
receiving, from a client device, information indicative of a selection of a plurality of services for inclusion in the service plan template.

10. One or more machine-readable storage media storing instructions that are executable by one or more processing devices to perform operations comprising:
accessing information indicative of a plurality of services included in a service plan template, with a service in the service plan template associated with a pricing model, and with the services in the service plan template being candidates for inclusion in a service plan;
obtaining usage information indicative of amounts of prior usage of the services included in the service plan template;
for a particular service included in the service plan template,
selecting an item of usage information that is indicative of an amount of prior usage of the particular service;
applying, to the selected item of usage information, a pricing model for the particular service;
generating, based on applying, a forecast of a charge for the particular service; and
generating, based on forecasts of charges for the services in the service plan template, a simulated invoice for the service plan template.

11. The one or more machine-readable storage media of claim 10, wherein the operations further comprise:
transmitting, to a client device, information indicative of the simulated invoice;
receiving, from the client device, information indicative of approval of the services in the service plan template for inclusion in the service plan; and
assigning the services to the service plan.

12. The one or more machine-readable storage media of claim 10, wherein the operations further comprise:
determining, based on the simulated invoice, a first amount of forecasted profitability for a provider that provides the services in the service plan template;
receiving, from the client device, information indicative of one or more modifications to the service plan template, with a modification comprising one or more of (i) a change in a type of service included in the service plan template, and (ii) a change in a pricing model of one of the services included in the service plan template;
generating, based on the one or more modifications, a modified service plan template;
updating, based on the one or more modifications and the usage information, the simulated invoice to represent forecasts of charges for services included in the modified service plan template;
determining, based on the updated simulated invoice, a second amount of forecasted profitability to the provider; and
determining, based on the first amount of forecasted profitability and the second amount of forecasted profitability, a change in an amount of forecasted profitability associated with the one or more modifications.

13. The one or more machine-readable storage media of claim 10, wherein the operations further comprise:
transmitting, to a client device, information indicative of a graphical user interface that when rendered on a display device, comprises:
a visual representation of the services included in the service plan template and the forecasts of the charges for the services.

14. The one or more machine-readable storage media of claim 10, wherein the operations further comprise:
generating a plurality of invoices for a plurality of consumers, with an invoice being for a consumer, and with the invoice including information indicative of amounts of services used by the consumer; and
selecting a particular invoice from the plurality of invoices;
wherein obtaining the usage information indicative of the amounts of prior usage of the services included in the service plan template comprises:
identifying, in the selected particular invoice, information indicative of amounts of the services included in the service plan template that are used by one of the plurality of consumers who is associated with the selected particular invoice.

15. The one or more machine-readable storage media of claim 10, wherein the operations further comprise:
accessing a group of invoices for a plurality of consumers, with an invoice being for a consumer, and with the invoice including usage information indicative of amounts of services used by the consumer;
generating, based on applying the pricing models to usage information included in the invoices in the group, a plurality of simulated invoices;
accessing information indicative of a first amount of revenue that is attributable to pricing models represented by the group of invoices;
determining, based on the simulated invoices, a second amount of revenue that is attributable to the pricing models represented by the service plan template; and
determining, based on comparing the first amount of revenue to the second amount of a revenue, a change in revenue that is attributable to the service plan template.

16. A system comprising:
one or more processing devices; and
one or more machine-readable storage media storing instructions that are executable by the one or more processing devices to perform operations comprising:
accessing information indicative of a plurality of services included in a service plan template, with a service in the service plan template associated with a pricing model, and with the services in the service plan template being candidates for inclusion in a service plan;
obtaining usage information indicative of amounts of prior usage of the services included in the service plan template;
for a particular service included in the service plan template,
selecting an item of usage information that is indicative of an amount of prior usage of the particular service;
applying, to the selected item of usage information, a pricing model for the particular service;
generating, based on applying, a forecast of a charge for the particular service; and
generating, based on forecasts of charges for the services in the service plan template, a simulated invoice for the service plan template.

17. The system of claim 16, wherein the operations further comprise:
transmitting, to a client device, information indicative of the simulated invoice;
receiving, from the client device, information indicative of approval of the services in the service plan template for inclusion in the service plan; and
assigning the services to the service plan.

18. The system of claim 16, wherein the operations further comprise:
determining, based on the simulated invoice, a first amount of forecasted profitability for a provider that provides the services in the service plan template;
receiving, from the client device, information indicative of one or more modifications to the service plan template, with a modification comprising one or more of (i) a change in a type of service included in the service plan template, and (ii) a change in a pricing model of one of the services included in the service plan template;
generating, based on the one or more modifications, a modified service plan template;
updating, based on the one or more modifications and the usage information, the simulated invoice to represent forecasts of charges for services included in the modified service plan template;
determining, based on the updated simulated invoice, a second amount of forecasted profitability to the provider; and
determining, based on the first amount of forecasted profitability and the second amount of forecasted profitability, a change in an amount of forecasted profitability associated with the one or more modifications.

19. The system of claim 16, wherein the operations further comprise:
transmitting, to a client device, information indicative of a graphical user interface that when rendered on a display device, comprises:
a visual representation of the services included in the service plan template and the forecasts of the charges for the services.

20. The system of claim 16, wherein the operations further comprise:
generating a plurality of invoices for a plurality of consumers, with an invoice being for a consumer, and with the invoice including information indicative of amounts of services used by the consumer; and
selecting a particular invoice from the plurality of invoices;
wherein obtaining the usage information indicative of the amounts of prior usage of the services included in the service plan template comprises:
identifying, in the selected particular invoice, information indicative of amounts of the services included in the service plan template that are used by one of the plurality of consumers who is associated with the selected particular invoice.
